(19) United States
(12) Patent Application Publication
(10) Pub. No.: US 2002/0104421 A1
(43) Pub. Date: Aug. 8, 2002

(54) Saw blade

(76) Inventor: Bert G. Wurst, Stuttgart (DE)

Correspondence Address: ST. ONGE STEWARD JOHNSTON & REENS, LLC, 986 BEDFORD STREET, STAMFORD, CT, 06905-5619, US

(21) Appl. No.: 09/961,905

(22) Filed: Sep. 24, 2001

(30) Foreign Application Priority Data
Sep. 23, 2000 (DE) DE 100 47 212.5

(51) Int. Cl. B27B 33/02

(52) U.S. Cl. 83/835; 83/848

(57) ABSTRACT

A saw blade is disclosed which comprises a fixing receptacle for fixation on an oscillating drivable drive shaft, having a cutter that is distanced from the fixing receptacle, the cutter extending essentially tangentially or arch-shaped with respect to the fixing receptacle and being provided with a plurality of saw teeth. The cutter comprises at least a first section and a second section, and the saw teeth have at least in the area of one section another spacing or another set of saw teeth than in the other section. The saw blade allows a precise application to the object to be cut and a later continuation of the cutting process with increased feed.

### BACKGROUND OF THE INVENTION

The invention relates to a saw blade comprising a fixing receptacle for fixation on an oscillatingly drivable drive shaft, with a cutter that is distanced from the fixing receptacle, this cutter extending essentially tangentially or arch-shaped with respect to the fixing receptacle and being provided with a plurality of saw teeth, wherein the cutter comprises at least a first section and a second section.

Such a saw blade is known from EP 0 881 023 A2.

The known saw blade comprises a cutter that extends longitudinally with respect to the fixing receptacle and that is additionally, if necessary, slightly angled at two lateral sections with respect to a center section.

Such cutting tools can be used for special tasks in connection with an oscillating drive with a high frequency in the order of magnitude of approximately 3000-25000 oscillations per minute and with a small pivot angle of approximately 0.5-5°, for instance to facilitate the creation of rectangular recesses on wood, gypsum or the like. Moreover, also circular shaped and circle segment shaped saw blades are known that are also used in connection with oscillating drives for such special cutting tasks.

In order to be able to achieve cuts as precise as possible, a spacing as small as possible should be chosen, so that the saw blade is provided with a plurality of saw teeth. This results, however, in the disadvantage of a slower operating speed.

### SUMMARY OF THE INVENTION

The object of the invention is therefore to improve a saw blade of the kind mentioned at the outset in such a way that cuts as precisely as possible can be achieved and, at the same time, a good feed during the cut is guaranteed.

According to the invention this object is achieved for a saw blade according to the kind mentioned at the outset by the fact that the saw teeth have at least in the area of the first section another spacing or another set of saw teeth than in the second section.

The object of the invention is in that way completely achieved.

In that way, the spacing at one of the two sections can be chosen more finely than at the other section, whereby it is made possible to let the saw blade first, at the beginning of a cut, operate with a fine spacing in order to allow a good application. As soon as the beginning of the cut is performed, the saw blade can be moved in such a way that the other section is used, which is provided with a coarser spacing or with a broader set of saw teeth, so that now it is possible to operate with a higher feed.

The term “set of saw teeth” shall mean that a saw blade comprises saw teeth, which protrude over both outer surfaces of the saw blade. The saw teeth, which protrude generally alternately over the one outer surface and over the other outer surface, have, thus, lateral edges, the largest distance of which is larger than the thickness of the saw blade. If this set of saw teeth is varied, i.e. the distance of the two planes defined by the saw teeth on the one outer surface and the other outer surface, an easy application and a precise beginning of the cut can also be achieved in this manner, so that, subsequently, in operation with the center section, a larger feed can be achieved.

This measure can, of course, be combined with a variation of the spacing.

According to another embodiment of the invention, the cutter is curved in a circular arc-shaped manner and has a center of curvature that coincides with the fixing receptacle. The saw blade may here comprise either a circular or a circle segment shaped basic shape.

According to an alternative embodiment, the saw blade has basically a longitudinal shape, wherein the fixing receptacle is configured in the region of a first end and the cutter is configured at the opposite second end.

By means of such a shape of a saw blade, sawing operations can be performed at places that are difficult to access.

According to another embodiment of the invention, the cutter comprises more than two sections of which at least two have a spacing or set of saw teeth deviating from each other.

By dividing the cutter into a larger number of sections, an even more favorable adjustment to the cutting process can be guaranteed so that e.g. working can be performed at the beginning of the cut with a particularly fine spacing in order to guarantee a precise start of the cut, subsequently with a spacing that is somewhat coarser, and, finally, in the further cutting process, with a still coarser spacing in order to guarantee a quick feed.

According to another embodiment of the invention, the cutter has a first, a second and a third section, wherein the first section is configured as a middle section that is enclosed on both sides by the second and the third section.

By means of such a form, the saw blade can, at the beginning of the cut, be applied at will from the one or from the other side and, subsequently, it can be worked with the middle section in the cutting process.

Preferably, the saw teeth of one section have a finer spacing and/or a smaller set than at the second section.

It is to be understood, further, that it is sufficient to configure merely one of the two sections in comparison to the other section deviating with reference to spacing or set of saw teeth. In this case, the saw blade is always applied from one side, namely, generally, at the section with the finer spacing and/or the narrower set of teeth and, subsequently, is operated with the other region.

According to another embodiment of the invention, the spacing from one of the sections decreases continuously at least into the direction of one of the other sections.

Alternatively or additionally to that, the set of saw teeth from one of the sections becomes continuously narrower at least into the direction of one of the other sections.

In this way, a gradual transition is made possible from operating with a fine spacing and/or with narrow set of saw teeth, i.e. from operating with a relatively slow feed with higher precision, to a subsequent operating with a larger spacing and/or larger set of saw teeth, so that the user of the saw blade is offered an optimal variability.

By contrast, it is possible, of course, to provide the first section continuously with a different spacing and/or set of saw teeth than one of the other sections.

In addition, further sections of the cutter may be added, the spacing or the set of saw teeth of which, respectively, are further varied, generally using intermediate values between adjacent sections.

According to another embodiment of the invention, at least the first section of the cutter extends tangentially with respect to the fixing receptacle.

By means of such a shape, working in spatially closely limited circumstances is made possible, in order to perform e.g. a sawing operation alongside a wall or a floor surface.

Herein, the second and a third section can be angled at least partially with respect to the first section, in order to reduce somewhat the vibrations during operation.

According to another embodiment of the invention, the cutter is configured as a double cutter with two tooth rows being distanced from each other.

In an improved embodiment of this embodiment, two tooth rows terminate flush with each of the two outer surfaces of the saw blade.

By means of such an embodiment, a particularly precise cut can be achieved, wherein a chip removal can be guaranteed via a spacing between the two tooth rows.

In such an embodiment, the distance between the two tooth rows is preferably kept constant and merely the spacing in the center section and/or the lateral sections is adjusted in the desired manner.

It is to be understood that the features mentioned above and those yet to be explained below can be used not only in the respective combinations indicated, but also in other combinations or in isolation, without leaving the scope of the present invention.

### BRIEF DESCRIPTION OF THE DRAWINGS

Further features and advantages of the invention can be taken from the following description of preferred embodiments with reference to the drawings. In the drawings:

FIG. 1 shows a view of a first embodiment of a saw blade according to the invention, in the shape of a segment saw blade;

FIG. 2 shows a view of another embodiment of a segment saw blade according to the invention;

FIG. 3 shows a top view of another embodiment of a saw blade according to the invention having a longitudinal shape;

FIG. 4 shows a partial cross section through another embodiment of a saw blade in the region of its teeth;

FIG. 5 shows another partial cross section through another variation of a saw blade in the region of its teeth;

FIG. 6 shows a top view of a variation of the embodiment according to FIG. 3; and

FIG. 7 shows another variation of the saw blade having a circular basic shape in top view.

### DETAILED DESCRIPTION OF THE PREFERRED EMBODIMENTS

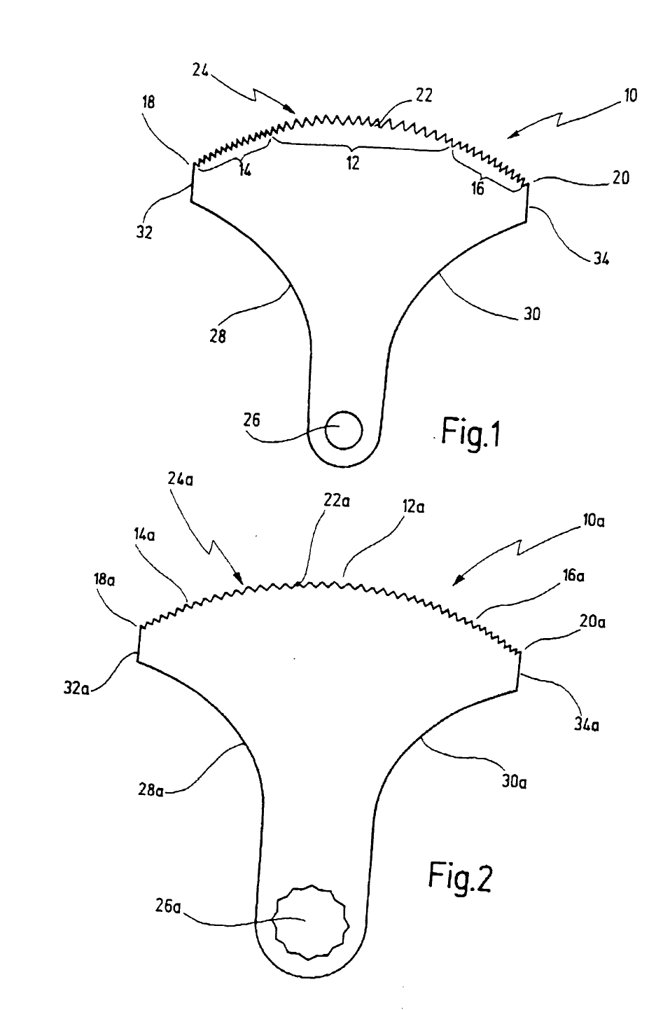

In FIG. 1, a saw blade according to the invention in the shape of a segment saw blade is shown in top view and designated altogether with the numeral 10. Saw blade 10 has a fixing receptacle 26 in the shape of an opening, by means of which it can be fixed on an oscillatingly drivable drive shaft of an oscillation drive of known design, e.g. by means of a nut or the like. Saw blade 10 has a cutter 24, which is configured in a circular arc-shaped manner and the center of curvature of which extends through fixing receptacle 26. If saw blade 10 is driven, thus, by means of a rotating oscillation drive about fixing receptacle 26 in an oscillating to-and-fro manner, all points on the surface of cutter 24 move on a circular arc, so that an operation with little vibrations is made possible.

Saw blade 10 has a plain surface and transits into curved cutter 24, starting from fixing receptacle 26, via two concave curved lateral edges 28, 30 and adjoining hereto short straight lateral edge sections 32 or 34, respectively. In the top view according to FIG. 1, saw blade 10 has, thus, approximately the shape of a mushroom.

Cutter 24, which consists of a plurality of single saw teeth 22, has a first middle section 12, a second section 14 and a third section 16, which adjoin as lateral sections 14, 16 on the one or on the other side of first section 12, respectively, and end in a first end 18 or in a second end 20, respectively, at the transition to the straight lateral edge sections 32 or 34, respectively.

Alongside second and third sections 14, 16, saw teeth 22 are arranged having a smaller distance to each other, i.e. with a smaller spacing than in first section 12.

It is to be understood that the representation in FIG. 1 is merely an example and schematically indicates merely one of the different possible embodiments. The size of teeth 22 shown and also the spacing in first section 12 and in two other sections 14, 16 does not necessarily correspond to the real dimensions and can be adjusted to the respective material to be sawed. For example, the spacing of sections 14, 16 can become 0, i.e. sections 14, 16 are configured as smooth knives or are provided with an undulated grinding.

For harder and tougher materials, such as metals, in first section 12 as well as in the other two sections 14, 16, smaller teeth 22 and basically smaller spacing will generally be used than e.g. on a saw blade configured for working wood or plastic. Moreover, also the angled regions can, of course, be varied. While, in the embodiment shown in FIG. 1, the first section, starting from fixing receptacle 26, extends over an angle of approximately 40°, and the two sections each extend over an angle of approximately 20°, these relations can also be adjusted depending on the desired application.

Further, it is also possible, to configure merely one of the two lateral sections 14, 16 deviating from middle section 12 instead of configuring both lateral sections 14, 16 deviating from the middle section 12 having a constant spacing or set of saw teeth. This would make sense, if e.g. the saw blade concerned is to be applied always from one side, and, subsequently, the work is to be continued mainly with the remaining region.

By means of the embodiment shown in FIG. 1, an easy and exact applying and a simple beginning of the cut at one of the two lateral sections 14, 16 is made possible, while, subsequently, for the sake of a higher feed, the work is continued with the middle section or with first section 12.

It is to be understood that, in addition, instead of a distribution into a middle section and two lateral sections, also further sections can be provided, within same the spacing is further varied, preferably to an intermediate value between adjacent sections.

When the spacing is determined, also the coarsest spacing is suitably chosen so small that it is smaller than the circular arc spanned by the pivot angle of the oscillation drive of e.g. 0.5-5°.

In FIG. 2, a variation of the embodiment according to FIG. 2 is shown and altogether designated with the numeral 10a.

For corresponding parts, corresponding reference numerals followed by a are used. The outer shape of the embodiment according to FIG. 2 is essentially equal to the embodiment according to FIG. 1.

A first difference is a modified shape of the receptacle opening 26a that is configured as a star-shaped polygon in order to allow a positive engaging with a suitably shaped receptacle socket of a drive shaft of the associated oscillation drive, as it is generally already known.

Further, cutter 24a of saw blade 10a differs from saw blade 10 described before by the fact that the spacing of saw teeth 22a from the center of first center section 12a continuously decreases into the direction of the two ends 18a or 20a, respectively.

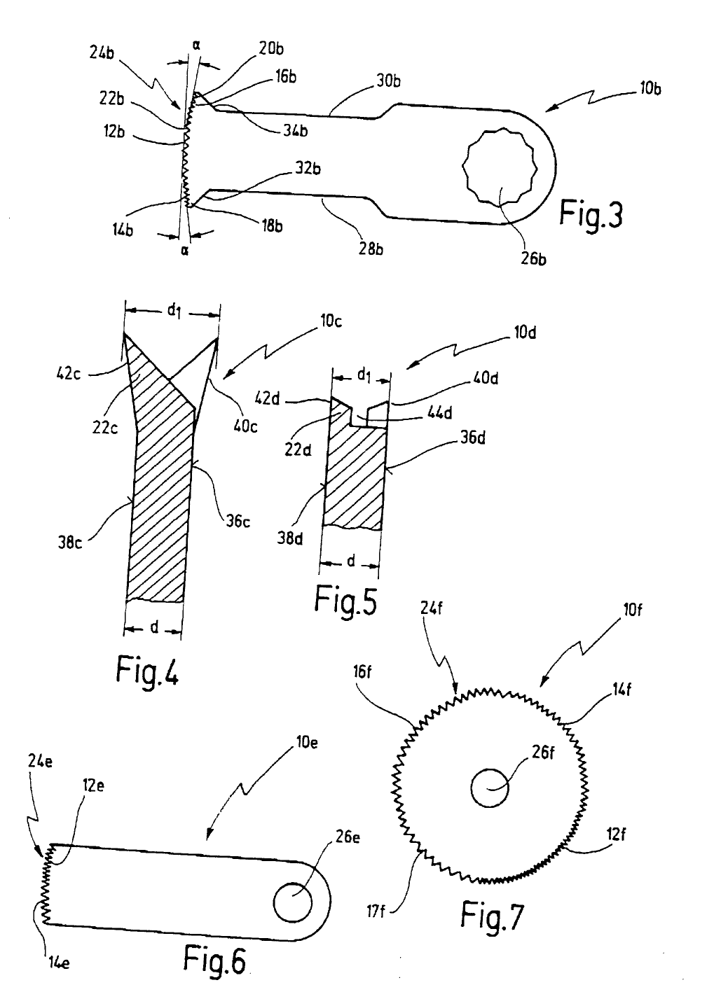

A further modification of a saw blade according to the invention is shown in FIG. 3 and designated altogether with the reference numeral 10b. For corresponding parts also herein, again, corresponding reference numerals followed by b are used.

Saw blade 10b has a longitudinal shape and has, starting from fixing receptacle 26b, two lateral edges being parallel to each other, which each, in a front region facing away from fixing receptacle 26b, form a taper into the direction of the center, and transit into cutter 24b via short straight sections 32b or 34b, respectively, that extend inclined outwardly.

Cutter 24b has a first middle straight section 12b that extends tangentially with respect to fixing receptacle 26b, a second straight section 14b adjoining at one side, and a third straight section 16b adjoining at the other side, both straight sections transiting in a small angle [symbol] of approximately 2-10° into first section 12b.

Again, the spacing of saw teeth 22b in the region of first section 12b is larger than in the region of the two lateral sections 14b or 16b, respectively.

It is to be understood that instead also first section 12b as well as two lateral sections 14b, 16b can be configured in a continuously linear manner.

In FIGS. 4 and 5, another alternative is explained for the saw blade according to the invention which utilizes a variation of the set of saw teeth.

In FIG. 4, a partial section through a saw blade 10c according to the invention in the edge region of saw teeth 22c is shown. Saw blade 10c has two tooth rows 40c or 42c, respectively, which protrude over one outer surface 36c or over the other outer surface 38c, respectively. These two tooth rows 40c or 42c, respectively, define two planes, the distance between which is d₁, as shown in FIG. 4.

This dimension d₁ is larger than thickness d of saw blade 10c. The individual teeth 22c of saw blade 10c alternately protrude outwardly over one outer plane 38c or over other outer plane 36c, respectively.

For saw blade 10c, now the set of saw teeth defined in this way is varied such that in the center area of the saw blade a larger set of saw teeth, i.e. a larger dimension d₁ is used than at the lateral sections.

By means of a larger set of saw teeth, a stronger cut and a larger feed is made possible, whereas, with a smaller set of saw teeth, a more precise cut with a low feed is made possible. If, thus, the set of saw teeth is smaller in the lateral sections than in the middle section, the saw blade can be applied more easily, whereas, subsequently, it is possible to continue work quicker with the middle section.

It is to be understood that, in addition to the set of saw teeth, the spacing of teeth 22c can be varied at the same time.

A further alternative of a saw blade according to the invention is shown in FIG. 5 partially cut in the region of the saw teeth and designated altogether with the numeral 10d.

Again, corresponding reference numerals followed by d are used for corresponding parts.

Saw blade 10d shown has the special feature that, in deviation of the embodiment shown in FIG. 4, two tooth rows 40d or 42d, respectively, being distanced from each other are provided, between which, in the center, a spacing 44d is formed. The two tooth rows 40d and 42d are configured such that they each terminate outwardly flush with outer surfaces 36d or 38d, respectively.

In that way, a particularly precise cut is made possible, since distance d₁ of teeth 22d corresponds to thickness d of saw blade 10d.

In such an embodiment, of course, not the set of saw teeth is varied, but merely the spacing along the cutter.

A variation of the embodiment according to FIG. 3 is shown in FIG. 6 and designated altogether with the numeral 10e.

This saw blade, too, has basically a longitudinal shape having a fixing receptacle 26e at the one end and a cutter 24e at the other end. Fixing receptacle 26e, however, is not configured as a polygon opening, but as a circular opening. Cutter 24e is circular arc-shaped and has only two sections, 12e, 14e, of which first section 12e has a finer spacing than second section 14e.

A further variation of the saw blade according to the invention is shown in FIG. 7 and designated altogether with the numeral 10f.

Saw blade 10f has herein a circular basic shape and is provided with cutter 24f at its edge. The cutter has four sections 12f, 14f, 16f, 17f, which are provided with saw teeth of different spacing. In this embodiment, at section 12f with the smallest spacing, a section 14f with a somewhat larger spacing adjoins, followed by a section 16f with an even larger spacing, at which section 17f adjoins with the largest spacing, which adjoins at first section 12f of the finest spacing.

Depending on the material to be worked or on the desired fineness of the cut, respectively, suitable sections 12f, 14f or 17f are used one after another in the working process.

What is claimed is:

1. A saw blade comprising a metal body having first and second ends;
a fixing receptacle arranged at said first end of said metal body for securing the saw blade to an oscillatingly drivable drive shaft;
a cutter arranged at said second end of said metal body, having at least first and second cutting sections adjoining each other, and being curved in a circular arc-shaped manner having a center of curvature that coincides with the fixing receptacle;
a plurality of saw teeth arranged on said cutter extending over said first and second cutting sections, said plurality of saw teeth having certain spacing and certain sets of saw teeth within said first and second cutting sections, wherein said plurality of saw teeth extending over said first cutting section have a spacing different from the spacing of saw teeth extending over said second cutting section.

2. A saw blade comprising a metal body having first and second ends;
a fixing receptacle arranged at said first end of said metal body for securing the saw blade to an oscillatingly drivable drive shaft;
a cutter arranged at said second end of said metal body, having at least first and second cutting sections adjoining each other, and being curved in a circular arc-shaped manner having a center of curvature that coincides with the fixing receptacle;
a plurality of saw teeth arranged on said cutter extending over said first and second cutting sections, said plurality of saw teeth having certain spacing and certain sets of saw teeth within said first and second cutting sections, wherein said plurality of saw teeth extending over said first cutting section have a set of saw teeth different from the set of saw teeth extending over said second cutting section.

3. A saw blade comprising a metal body having first and second ends;
a fixing receptacle arranged at said first end of said metal body for securing the saw blade to an oscillatingly drivable drive shaft;
a cutter arranged at said second end of said metal body, having first, second and third cutting sections adjoining each other, the first section being configured as a middle section, adjoining the second section at one end thereof, and adjoining the third section at another end thereof, said cutter being curved in a circular arc-shaped manner having a center of curvature that coincides with the fixing receptacle;
a plurality of saw teeth arranged on said cutter extending over said first and second cutting sections, said plurality of saw teeth having certain spacing and certain sets of saw teeth within said first and second cutting sections, wherein said plurality of saw teeth extending over said first cutting section have a spacing different from the spacing of saw teeth extending over at least one of said second and third cutting sections.

4. A saw blade comprising a metal body having first and second ends;
a fixing receptacle arranged at said first end of said metal body for securing the saw blade to an oscillatingly drivable drive shaft;
a cutter arranged at said second end of said metal body, having first, second and third cutting sections adjoining each other, the first section being configured as a middle section, adjoining the second section at one end thereof, and adjoining the third section at another end thereof, said cutter being curved in a circular arc-shaped manner having a center of curvature that coincides with the fixing receptacle;
a plurality of saw teeth arranged on said cutter extending over said first and second cutting sections, said plurality of saw teeth having certain spacing and certain sets of saw teeth within said first and second cutting sections, wherein said plurality of saw teeth extending over said first cutting section have a set of saw teeth different from the set of saw teeth extending over at least one of said second and third cutting sections.

6. The saw blade of claim 1, wherein the saw teeth of one of said cutting sections have a finer spacing than have the saw teeth of another cutting section.

7. The saw blade of claim 1, wherein the saw teeth of one of said cutting sections have a narrower set than have the saw teeth of another cutting section.

8. The saw blade of claim 1, wherein the saw teeth of one of said cutting sections have a spacing that decreases continuously towards an end of said cutting section.

9. The saw blade of claim 1, wherein the set of saw teeth of one of said cutting sections becomes continuously narrower toward another one of said cutting sections.

10. The saw blade of claim 2, wherein the saw teeth of one of said cutting sections have a finer spacing than have the saw teeth of another cutting section.

11. The saw blade of claim 2, wherein the saw teeth of one of said cutting sections have a narrower set than have the saw teeth of another cutting section.

12. The saw blade of claim 2, wherein the saw teeth of one of said cutting sections have a spacing that decreases continuously towards an end of said cutting section.

13. The saw blade of claim 2, wherein the set of saw teeth of one of said cutting sections becomes continuously narrower toward another one of said cutting sections.

14. The saw blade of claim 3, wherein the saw teeth of one of said cutting sections have a finer spacing than have the saw teeth of another cutting section.

15. The saw blade of claim 3, wherein the saw teeth of one of said cutting sections have a narrower set than have the saw teeth of another cutting section.

16. The saw blade of claim 3, wherein the saw teeth of one of said cutting sections have a spacing that decreases continuously towards an end of said cutting section.

17. The saw blade of claim 3, wherein the set of saw teeth of one of said cutting sections becomes continuously narrower toward another one of said cutting sections.

18. The saw blade of claim 4, wherein the saw teeth of one of said cutting sections have a finer spacing than have the saw teeth of another cutting section.

19. The saw blade of claim 4, wherein the saw teeth of one of said cutting sections have a narrower set than have the saw teeth of another cutting section.

20. The saw blade of claim 4, wherein the saw teeth of one of said cutting sections have a spacing that decreases continuously towards an end of said cutting section.

21. The saw blade of claim 4, wherein the set of saw teeth of one of said cutting sections becomes continuously narrower toward another one of said cutting sections.

22. The saw blade of one of claim 1, wherein at least said first cutting section of said cutter extends tangentially with respect to said fixing receptacle.

23. The saw blade of one of claim 2, wherein at least said first cutting section of said cutter extends tangentially with respect to said fixing receptacle.

24. The saw blade of one of claim 3, wherein at least said first cutting section of said cutter extends tangentially with respect to said fixing receptacle.

25. The saw blade of one of claim 4, wherein at least said first cutting section of said cutter extends tangentially with respect to said fixing receptacle.

26. The saw blade of claim 3, wherein said second and third sections are angled at least partially with respect to said first section.

27. The saw blade of claim 4, wherein said second and third sections are angled at least partially with respect to said first section.

28. The saw blade of claim 1, wherein said cutter is configured as a double cutter having two tooth rows being distanced from each other in a direction transverse to said fixing receptacle.

29. The saw blade of claim 28, wherein said metal body comprises a first surface and a second surface opposite to said first surface, and wherein each one of said two tooth rows terminates flush with one of said first and second surfaces.

30. A saw blade comprising a metal body having at least partially a circular shape defining a center of curvature;
a fixing receptacle arranged at said center of curvature for securing the saw blade to an oscillatingly drivable drive shaft;
a cutter arranged at a circular edge of said metal body, having at least first and second cutting sections adjoining each other;
a plurality of saw teeth arranged on said cutter extending over said first and second cutting sections, said plurality of saw teeth having certain spacing and certain sets of saw teeth within said first and second cutting sections, wherein said plurality of saw teeth extending over said first cutting section have a spacing different from the spacing of saw teeth extending over said second cutting section.

31. A saw blade comprising a metal body having at least partially a circular shape defining a center of curvature;
a fixing receptacle arranged at said center of curvature for securing the saw blade to an oscillatingly drivable drive shaft;
a cutter arranged at a circular edge of said metal body, having at least first and second cutting sections adjoining each other;
a plurality of saw teeth arranged on said cutter extending over said first and second cutting sections, said plurality of saw teeth having certain spacing and certain sets of saw teeth within said first and second cutting sections, wherein said plurality of saw teeth extending over said first cutting section have a set of saw teeth different from the set of saw teeth extending over said second cutting section.

32. The saw blade of claim 30, wherein said cutter is configured as a double cutter having two tooth rows being distanced from each other in a direction transverse to said fixing receptacle.

33. The saw blade of claim 32, wherein said metal body comprises a first surface and a second surface opposite to said first surface, and wherein each one of said two tooth rows terminates flush with one of said first and second surfaces.

34. The saw blade of claim 31, wherein said cutter is configured as a double cutter having two tooth rows being distanced from each other in a direction transverse to said fixing receptacle.

35. The saw blade of claim 34, wherein said metal body comprises a first surface and a second surface opposite to said first surface, and wherein each one of said two tooth rows terminates flush with one of said first and second surfaces.

36. The saw blade of claim 30, wherein the saw teeth of one cutting section have a narrower set than have the saw teeth of another cutting section.

37. The saw blade of claim 31, wherein the saw teeth of one cutting section have a narrower set than have the saw teeth of another cutting section.

38. The saw blade of claim 30, wherein the spacing of the saw teeth of one cutting section decreases continuously toward another one of said cutting sections.

39. The saw blade of claim 30, wherein the set of saw teeth of one cutting section becomes continuously narrower toward another one of said cutting sections.

40. The saw blade of claim 31, wherein the spacing of the saw teeth of one cutting section decreases continuously toward another one of said cutting sections.

41. The saw blade of claim 31, wherein the set of saw teeth of one cutting section becomes continuously narrower toward another one of said cutting sections.

42. A saw blade comprising a metal body having a fixing receptacle for securing the saw blade to an oscillatingly drivable drive shaft, and further having a cutter arranged at a distance from the fixing receptacle, said cutter having at least first and second cutting sections;
a plurality of saw teeth arranged on said cutter and extending over said first and second cutting sections, said plurality of saw teeth having certain spacing and certain sets of saw teeth within said first and second cutting sections, wherein said plurality of saw teeth extending over said first cutting section have a set of saw teeth different from the set of saw teeth extending over said second cutting section.

43. A saw blade comprising a metal body having a fixing receptacle for securing the saw blade to an oscillatingly drivable drive shaft, and further having a cutter arranged at a distance from the fixing receptacle, said cutter having at least first and second cutting sections;
a plurality of saw teeth arranged on said cutter and extending over said first and second cutting sections, said plurality of saw teeth having certain spacing and certain sets of saw teeth within said first and second cuffing sections, wherein said plurality of saw teeth extending over said first cutting section have a spacing different from the spacing of said plurality of saw teeth extending over said second cutting section.
